(19) United States
(12) Patent Application Publication
(10) Pub. No.: US 2013/0006993 A1
(43) Pub. Date: Jan. 3, 2013

(54) PARALLEL DATA PROCESSING SYSTEM, PARALLEL DATA PROCESSING METHOD AND PROGRAM

(75) Inventor: Dai Kobayashi, Tokyo (JP)

(73) Assignee: NEC CORPORATION, Minato-ku, Tokyo (JP)

(21) Appl. No.: 13/582,775

(22) PCT Filed: Mar. 4, 2011
(86) PCT No.: PCT/JP2011/055040

§ 371 Date: Sep. 5, 2012

(30) Foreign Application Priority Data
Mar. 5, 2010 (JP) 2010-049473

(51) Int. Cl. G06F 17/30

(52) U.S. Cl. 707/737; 707/E17.046

(57) ABSTRACT

A parallel data processing system comprises: a unit of processing that generates, reads out or updates an object or relevant information on objects; a consistency controller that returns to the unit of processing a consistency value for an object within each object cluster; and an object to cluster association resolving unit that receives an identifier of an object to return an identifier of a consistency controller for an object cluster including the object, wherein, in generating, reading out or updating an object or relevant information on objects, the unit of processing acquires an identifier of a consistency controller for an object cluster including the object from the object to cluster association resolving unit, and performs consistency control based on the consistency controller, while the unit of processing accesses an object storage unit.

### TECHNICAL FIELD

### Cross-Reference to Related Application

The present invention claims priority based on JP Patent Application 2010-049473 filed in Japan on Mar. 5, 2010. The entire contents of disclosure of the patent application of the senior filing date are incorporated herein by reference thereto.

The present invention relates to a parallel data processing system, a parallel data processing method and a program. More particularly, the present invention relates to a parallel data processing system, a parallel data processing method and a program, in which, in case data contained in a data set represented by a graph structure are stored distributed in a plurality of computers, the data may be processed in parallel.

### BACKGROUND

There has been known a technique that represents data by a graph structure. For example, Non-Patent Literature 1 shows an object-oriented database technology according to which a data set is represented by links among the objects. Non-Patent Literature 2 shows a knowledge base technology according to which the relationship among data is represented by links. Patent Literature 1 shows a database technology according to which data stored are expressed by XML documents and exploited as data of a tree structure which is a sort of a graph. Non-Patent Literature 3 shows a database technology according to which data are stored and exploited in an RDF (Resource Description Framework) which represents data by a relationship of a ‘triple’ structure among data.

There is also known a technology in which HDDs (Hard Disk Devices) and memories of a larger number of computers, interconnected over a network, are used to store and exploit the data. For example, Non-Patent Literature 4 shows a technology in which, to provide data to users, data units, termed data items or objects, are distributed and stored by a technique termed consistent hashing (Consistent Hashing) among a plurality of computers composing a system. The data so distributed and stored are offered to users. Non-Patent Literature 5 shows a technology in which a data structure termed a BigTable, constructed for the total of a plurality of the computers based on data units formed by a plurality of column data termed rows (Rows), is managed and presented.

To provide integrated data to a plurality of entities, transaction control is necessitated. Non-Patent Literature 6, for example, shows a technology in which a plurality of sorts of locks with different strengths are acquired for data of different values of granularity to diminish the lock acquisition time as loss of data consistency is prevented from occurring. Patent Literature 2 shows a technique of separately holding an internal database for retention of relation to enable integrated retrieval of the distributed databases.
[Patent Literature 1] JP Patent Kohyo Publication No. JP-P2004-515836A
[Patent Literature 2] JP Patent Kokai Publication No. JP-P2005-234612A
[Non-Patent Literature 1] Oomoto, Takamatsu and Tanaka, “Path Existence Constraints in Object Databases and its Applications,” Technical Report of the Institute of Electronics, Information and Communication Engineers, D.E. 95 (147), Institute of Electronics, Information and Communication Engineers, pp. 113-120, 1995.
[Non-Patent Literature 2] V. K. Chaudhri, “TRANSACTION SYNCHRONIZATION IN KNOWLEDGE BASES: Concepts, Realization and Quantitative Evaluation,” Ph.D. thesis, Univ. Tronto, 1995.
[Non-Patent Literature 3] Matono, Pahlevi and Kojima, “P2P-based Query Processing for Distributed RDF Databases Using a Three-dimensional Hash Index,” Transactions of Information Processing Society of Japan, Database vol. 47 (SIG_{—}8 (TOD_{—}30)), pp. 121-133, 2006.
[Non-Patent Literature 4] G. DeCandia et al., “Dynamo: Amazon's Highly Available Key-value Store,” in Proceedings on 21st ACM Symposium on Operating Systems Principles (SOSP 2007), pp. 205-220, 2007.
[Non-Patent Literature 5] Fay Chang et al., “Bigtable: A Distributed Storage System for Structured Data,” OSDI '06: Processing of the 7th USENIX Symposium on Operating Systems Design and Implementation, pp. 205-218, 2000.
[Non-Patent Literature 6] Jim Gray, Andreas Reuter, “Transaction Processing Concept and Technique, Vols 1 and 2,” Nikkei BP SHA, 2001.
[Non-Patent Literature 7] Alan Fekete et al., “Making Snapshot Isolation Serializable,” ACM Transactions on Database Systems (TODS), Vol. 30, No. 2, pp. 492-528, 2005.

### SUMMARY

The entire of the disclosures of the above Patent Literatures 1, 2 and the Non-Patent Literatures 1 to 7 is incorporated herein by reference thereto. The following analyses are given by the present invention.

In a data storage system, constructed by a large number of computers, consistency control in the processing of update/readout request for a data set represented by a graph structure is now scrutinized.

The conventional system according to the customary consistency control technique lacks in scalability. The reason is that, since it is requested to maintain transactionality for the entire data set, the consistency retention mechanism that should apply to the dataset in its entirety becomes a bottleneck.

On the other hand, the conventional data storage system, which seeks after scalability, provides only the consistency retention function from one single object to another. According to the technique described in the Non-Patent Literature 4 or Non-Patent Literature 5, only the consistency retention function on the object basis or on the row basis is provided. Viz., updates from a single transaction on a plurality of objects, such as object A and object B, are processed individually, such that, in readout at a certain time point, the same transaction can read out a new object A and an old object B. With object-based consistency retention, scalability may be improved, however, it is not possible to cope with an application in need of stronger consistency.

In the database with the graph structure, it is not mandatory that consistency is to be represented throughout the entire data set, as indicated in the Non-Patent Literature 1. Viz., there is such an application in which it is sufficient that consistency is retained in a set of nodes interconnected by branches of the graph structure. The set of nodes is referred to below as an ‘object cluster’.

As a simplified method to retain the consistency in the object cluster, such a method may be thought of in which different systems are used for management from one pre-set object cluster to another. However, in a data set represented by the graph structure, there are cases where the branch information of the graph structure is updated. If the branch information of the graph structure is updated so that a plurality of object clusters are interconnected to become a single object cluster, the method of using different systems for management from one object cluster to another may not be used.

With the method stated in Patent Literature 2, the system lacks in scalability since an internal database for relation retention is needed from one object cluster pair to another. Moreover, in the method described in Patent Literature 2, transactionality of update is not taken into account.

Therefore, in case a plurality of units of processing store, provide or update data (or objects) represented by the graph structure, in the parallel data processing system, there is a need in the art to provide a parallel data processing system, a parallel data processing method and a program that not only to retain consistency from one object cluster to another but also guarantee scalability.

According to a first aspect of the present disclosure, there is provided a parallel data processing system comprising:

an object storage unit that holds a plurality of objects and relevant information on objects representing a relation among the plurality of objects;
a unit of processing that generates, reads out or updates an object or the relevant information on objects for the object storage unit;
a plurality of consistency controllers each provided for an object cluster that includes a set of objects related with each other through the relevant information on objects; each consistency controller returning to the unit of processing a consistency value for an object within each object cluster; and
an object to cluster association resolving unit that receives an identifier of an object to return an identifier of an object cluster including the object or an identifier of a consistency controller among the plurality of consistency controllers that is for an object cluster including the object, wherein
in generating, reading out or updating an object or relevant information on objects, the unit of processing acquires, from the object to cluster association resolving unit, an identifier of a consistency controller among the plurality of consistency controllers that is for an object cluster including the object; the unit of processing performing consistency control, based on the consistency controller, while the unit of processing is accessing the object storage unit.

According to a second aspect of the present disclosure, there is provided a parallel data processing method, in a parallel data processing system comprising:

an object storage unit that holds a plurality of objects and relevant information on objects representing a relation among the plurality of objects;
a unit of processing that generates, reads out or updates an object or the relevant information on objects for the object storage unit;
a plurality of consistency controllers each of which is provided for an object cluster that includes a set of objects related with each other through the relevant information on objects; each consistency controller returning to the unit of processing a consistency value for an object within each object cluster; and
an object to cluster association resolving unit that receives an identifier of an object to return an identifier of a consistency controller among the plurality of consistency controllers that is for an object cluster including the object, the method comprising:
by the process, in generating, reading out or updating an object or relevant information on objects, acquiring, from the object to cluster association resolving unit, an identifier of a consistency controller among the plurality of consistency controllers that is for an object cluster including the object; and
performing consistency control, based on a consistency controller among the plurality of consistency controllers that corresponds to the acquired identifier, while the unit of processing accesses the object storage unit.

According to a third aspect of the present disclosure, there is provided a program, in a parallel data processing system comprising:

an object storage unit that holds a plurality of objects and relevant information on objects representing a relation among the plurality of objects;
a unit of processing that generates, reads out or updates an object or the relevant information on objects for the object storage unit;
a plurality of consistency controllers each provided for an object cluster that includes a set of objects related with each other through the relevant information on objects; each consistency controller returning to the unit of processing a consistency value for an object within each object cluster; and
an object to cluster association resolving unit that receives an identifier of an object to return an identifier of a consistency controller among the plurality of consistency controllers that is for an object cluster including the object, the program causing a computer to execute:
in generating, reading out or updating an object or the relevant information on objects, acquiring, from the object to cluster association resolving unit, an identifier of a consistency controller among the plurality of consistency controllers that is for an object cluster including the object; and
performing consistency control, based on a consistency controller among the plurality of consistency controllers that corresponds to the acquired identifier, while accessing the object storage unit.

The present disclosure provides the following advantage, but not restricted thereto. In the parallel data processing system, parallel data processing method and the program, according to the present disclosure, when a plurality of units of processing store, provide and update data represented by a graph structure, it is possible to retain consistency from one object cluster to another as well as to guarantee scalability.

### BRIEF DESCRIPTION OF DRAWINGS

FIG. 1 is a block diagram showing the configuration of a parallel data processing system according to a first exemplary embodiment.

FIG. 2 likewise is a block diagram showing the configuration of the parallel data processing system according to the first exemplary embodiment.

FIG. 3 is a schematic view for illustrating object clusters.

FIG. 4 illustrates example processing by a unit of processing to cluster association resolving unit of the parallel data processing system according to the first exemplary embodiment.

FIG. 5 shows relation of correspondence between objects and object clusters in an object to cluster association resolving unit of the parallel data processing system according to the first exemplary embodiment.

FIG. 6 is a sequence diagram showing an example of a unit of processing not astride object clusters by the parallel data processing system according to the first exemplary embodiment.

FIG. 7 is a sequence diagram showing an example of a processing by the parallel data processing system according to the first exemplary embodiment, with the unit of processing being astride the object clusters and with no linking occurring among object clusters.

FIG. 8 is a sequence diagram showing an example of a unit of processing by the parallel data processing system according to the first exemplary embodiment for a case where a relation astride object clusters has been established.

FIG. 9 is a block diagram showing a configuration of a parallel data processing system according to a second exemplary embodiment.

FIG. 10 shows information stored in an object to cluster association resolving unit of the parallel data processing system according to the second exemplary embodiment.

FIG. 11 is a block diagram showing a configuration of a parallel data processing system according to a third exemplary embodiment.

### PREFERRED MODES

In the present disclosure, there are various possible modes, which include the following, but not restricted thereto. A parallel data processing system in a first mode may be the parallel data processing system according to the first aspect.

In a parallel data processing system in a second mode, the object to cluster association resolving unit may comprise: non-synchronized object versus cluster correspondence information that stores a relation between an identifier of an object and an identifier of a object cluster including the object, the relation being asynchronously updated;

cluster linkage information that, in case an object cluster is integrated to another object cluster, stores an identifier of the object cluster that has become extinct by the integration and an identifier of the object cluster as destination of the integration, in relation with each other; and
a corresponding cluster determining unit that receives an identifier of an object to acquire, from the identifier of the object and the non-synchronized object versus cluster correspondence information, an identifier of an object cluster to which the object belonged in the past, acquires, from the identifier of the object cluster and the cluster linkage information, an identifier of an object cluster to which the object currently belongs, or an identifier of a consistency controller among the plurality of consistency controllers that corresponds to the object cluster, and returns the acquired identifier.

A parallel data processing system in a third mode may further comprise:

a unit of processing to cluster association resolving unit that correlates and stores an identifier of a unit of processing and an identifier of an object cluster including an object being accessed by the process, wherein
the process, in forming, reading out or updating the object or the relevant information on objects, acquires, from the object to cluster association resolving unit, an identifier of a corresponding object cluster and an identifier of a consistency controller among the plurality of consistency controllers that is for the object cluster, and registers, before accessing to the object cluster, an identifier of the unit of processing and an identifier of the object cluster in the unit of processing to cluster association resolving unit.

A parallel data processing system in a fourth mode may further comprise:

a cluster linkage controller which, if an operation of linking a plurality of object clusters is generated from a process, acquires, from the unit of processing to cluster association resolving unit, a unit of processing which are performing processing for an object included in the plurality of object clusters and which has not been committed, and issues a command to abort the processing of the non-committed process.

In a parallel data processing system in a fifth mode,

the consistency controllers may perform consistency control by MVCC (Multiversion Concurrency Control) that exploits a plurality of versions of objects, and
the cluster linkage controller may provide a read-only unit of processing among the non-committed units of processing with a version of an object that precedes the linking of the plurality of object clusters.

In a parallel data processing system in a sixth mode, the object is one among a file of a file system, a set of metadata relevant to a file, a tuple of a relational database, data of an object database, a Key-values of a Key-Value store, a content delimited by tags of an XML document and a resource of an RDF (Resource Description Framework) document.

In a parallel data processing system in a seventh mode, the object cluster may be a set of objects interlinked by the relevant information on objects.

In a parallel data processing system in an eighth mode, the relevant information on objects may include bi-directional or uni-directional relation among objects.

A parallel data processing method in a ninth mode may be the above mentioned parallel data processing method according to the second aspect.

A program in a tenth mode may be the above mentioned program according to the second aspect.

A computer-readable storage medium in an eleventh mode may be a medium storing the above mentioned program.

In the parallel data processing system, parallel data processing method and the program, according to the present disclosure, in which consistency control is managed from one object cluster to another, it is possible to realize an application which may not be implemented by conventional object-based consistency control. Moreover, processing other than that of interlinking the objet clusters may be completed by the individual consistency controllers. Thus, even in case a system is formed by a large number of computers, it is possible to realize scalability proportional to the number of the object clusters. Additionally, object linking during the system operation may be coped with.

### First Exemplary Embodiment

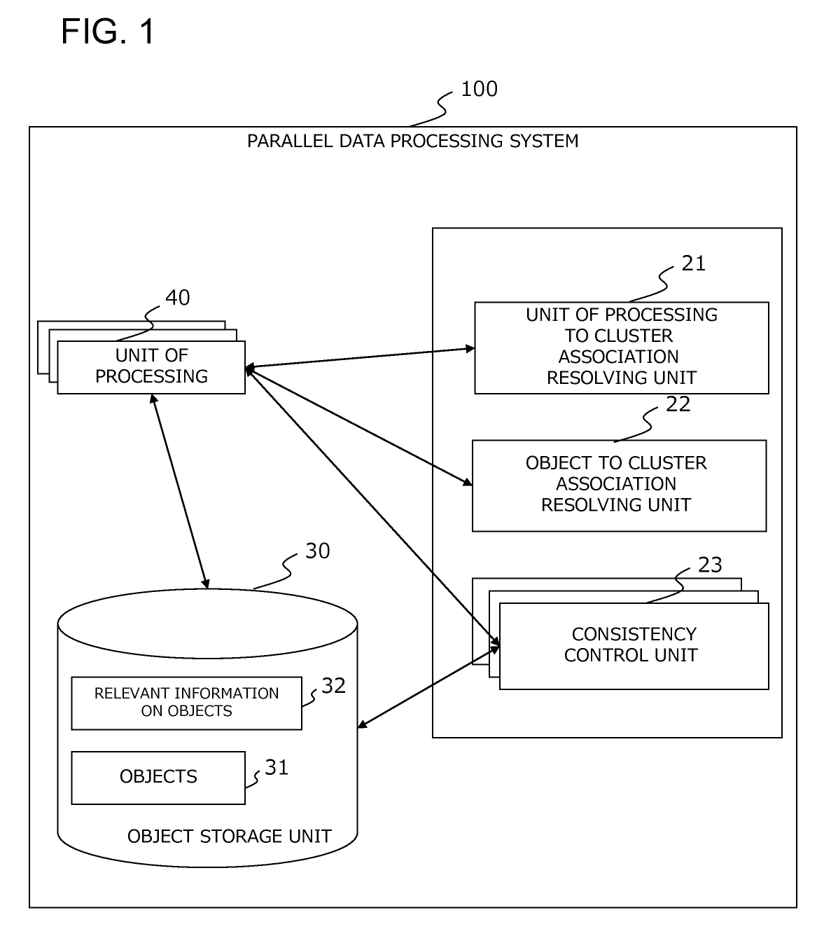

A parallel data processing system according to a first exemplary embodiment will now be described with reference to the drawings. FIG. 1 depicts a block diagram showing a configuration of a parallel data processing system 100 according to the present exemplary embodiment.

Referring to FIG. 1, the parallel data processing system 100 includes an object storage unit 30, a unit of processing 40, a unit of processing to cluster association resolving unit 21, an object to cluster association resolving unit 22 and a consistency control unit 23.

The object storage unit 30 stores objects and relevant information on objects, representing a relation among the objects.

The unit of processing 40 generates, reads out or updates the objects and the relevant information on objects for the object storage unit 30.

The consistency control unit 23 returns a consistency value for the objects in each object cluster to the unit of processing 40.

The object to cluster association resolving unit 22 receives an identifier of an object to return an identifier of an object cluster including the object of interest or an identifier of the consistency control unit 23 for the object cluster of interest.

The unit of processing to cluster association resolving unit correlates an identifier of the unit of processing with an identifier of the object cluster including the object being accessed by the unit of processing and stores the so correlated identifiers.

In generating, reading out or updating the objects or the relevant information on objects, the unit of processing 40 acquires an identifier of the consistency control unit 23 for the object cluster including the object of interest, from the object to cluster association resolving unit 22. The unit of processing 40 performs consistency control, based on the identifier of the consistency control unit acquired, while the unit of processing 40 accesses the object storage unit 30.

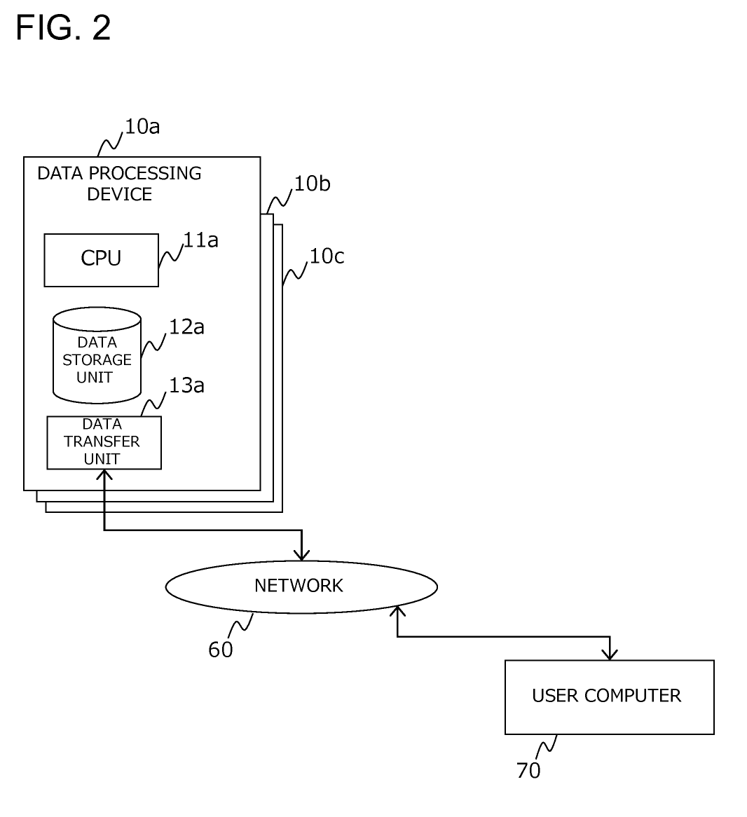

FIG. 2 depicts a block diagram showing a configuration of the parallel data processing system of the present exemplary embodiment in case the system is implemented by a plurality of data processing devices.

Referring to FIG. 2, the parallel data processing system comprises data processing devices 10a to 10c interconnected via a network 60. Although the number of the data processing devices shown is three, this is merely illustrative such that there is no limitation on the number of the data processing devices. A user computer 70, provided to a user making use of the parallel data processing system 100, is also connected to the network 60.

Referring to FIG. 2, the data processing devices 10a to 10c include CPUs 11a to 11c, data storage units 12a to 12c and data transfer units 13a to 13c, respectively. The CPUs 11a to 11c accomplish the functions of various units of the parallel data processing system 100 according to the present exemplary embodiment.

The data storage units 12a to 12c may, for example, be a control device that records data in a hard disk drive (HDD), a flash memory, a DRAM (Dynamic Random Access Memory), a MRAM (Magnetoresistive RAM), a FeRAM (Ferroelectric RAM), a PRAM (Phase Change RAM), a memory device coupled to a RAID controller, a physical medium capable of recording data, such as magnetic tape, or a medium installed outside a storage node.

The network 60 and the data transfer units 13a to 13c may, for example, be implemented by an upper layer protocol, such as e.g., Ethernet (registered trademark), Fibre Channel, FCoE (Fibre Channel over Ethernet (registered trademark)), Infiniband, QsNet, Myrinet, Ethernet, or TCP/IP as well as RDMA in which these are used. However, the network 60 may be implemented otherwise as well.

The unit of processing 40 is a program that issues at least one processing for a stored object, and is implemented by a program running on one or more of the CPUs 11a to 11c. As another configuration, the unit of processing 40 is a program on a computer, not shown, capable of exchanging data over the network 60. For example, a transaction in a transaction processing system may be regarded as being a single process.

The object storage unit 30 is implemented by the data processing devices 10a to 10c. The objects, each of which is user data, and the relationship among the objects, are respectively stored as objects 31 and the relevant information on objects 32 in the data storage units 12a to 12c.

The object is a set of one or more data that may be specified by an identifier. For example, each object represents data of the smallest unit semantically separated from a user. The objects may be enumerated by a file of a file system, a set of metadata relevant to a file, a tuple of a relational database, data of an object database, a Key-value of a Key-Value store, a content delimited by tags of an XML document, a resource of an RDF document, a data entity of Google App Engine, and a message of Microsoft Windows Azure cue. It should be noted that these are merely illustrative of the objects.

In the data storage units 12a to 12c, there is stored, as relevant information on objects 32, information showing the relationship among two or more objects. The relevant information on objects 32 is information a user or a system, handling the data, donates to indicate that two or more objects are related with each other. As for the relevant information on objects, there may be such a case where a given object has reference as metadata to another object. Also, a directory of a file system has the information regarding stored files, which information may also be regarded to be the relevant information on objects. Additionally, the XML structure in an XML document, if grasped as a tree structure, may also be regarded to be the relevant information on objects between parents and children. It should be noted that these are merely illustrative of the relevant information on objects.

An object cluster is a set of the objects interlinked by the relevant information on objects. Viz., if relation information between an object O_{X} and another object O_{Y} exists in the relevant information on objects 32, the objects O_{X}, O_{Y} belong to the same object cluster, for example, an object cluster C_{A}.

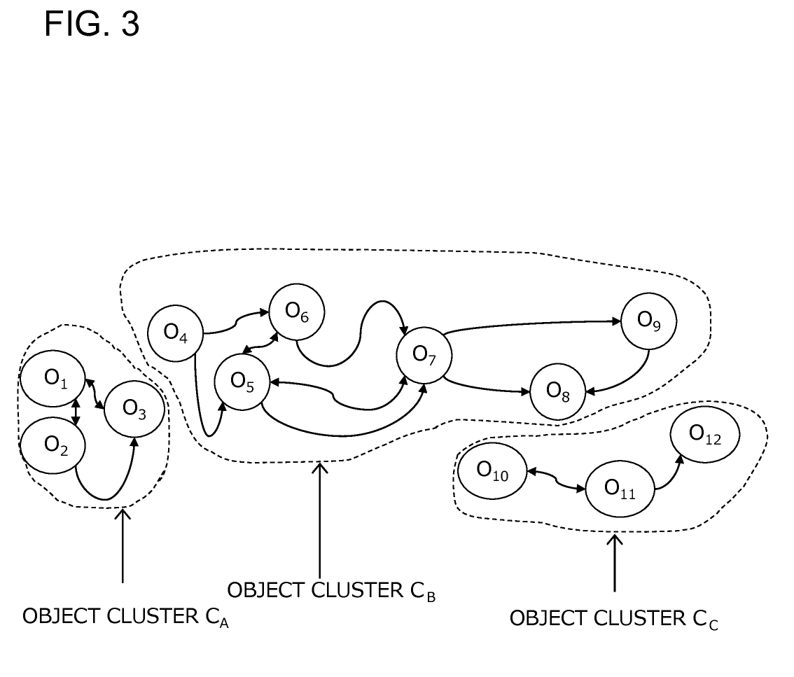

FIG. 3 shows, as typical configurations, a few object clusters each of which is formed by a plurality of objects and the relation information among the objects. Referring to FIG. 3, an object cluster C_{A} includes objects O₁ to O₃, an object cluster C_{B} includes objects O₄ to O₉ and an object cluster C_{C} includes objects O₁₀ to O₁₂.

It is now supposed that, in the state of FIG. 3, a new unit of processing 40 has generated the relevant information on objects between the object O₃ and the object O₄. In this case, if once the unit of processing 40 is committed and stored in the object storage unit 30, the total of the objects, contained in the object clusters C_{A} and C_{B}, are regarded to belong to the same object cluster.

The objects are stored distributed in the data processing devices 10a to 10c. This is made possible by, for example, contents hashing or distributed allocation by meta-servers. On the other hand, the relevant information on objects 32 may be stored in one location or donated from object to object for distributed storage in such state. The relevant information on objects 32 may have directivity. Viz., there may be such relevant information on objects in which there is a relation from an object O₁ to an object O₂, but in which there is no relation from the object O₂ to the object O₁, for example. It should be noted that the present exemplary embodiment regards that, in such case, the objects O₁ and O₂ have a relation to each other.

In case the parallel data processing system is implemented by a plurality of the data processing devices, the unit of processing to cluster association resolving unit, object to cluster association resolving unit and the consistency control unit are implemented by programs running on the CPUs 11a to 11c operating in concert with one another on the network 60. As another configuration, each data processing device may possess an individual hardware or a dedicated CPU each having the function of the unit of processing to cluster association resolving unit, object to cluster association resolving unit and the consistency control unit.

The unit of processing (or transaction) 40, operating on the user computer 70 or on the data processing devices 10a to 10c, is constituted by one or more of generation, readout, write/deletion of the objects and the relevant information on objects on the object storage unit 30. The unit of processing 40 is able to exploit data within the extent of consistency provided by the parallel data processing system 100. If this is not possible, the parallel data processing system 100 performs rollback or aborting. Viz., in the parallel data processing system 100 of the present exemplary embodiment, if data formulation, readout, write or deletion may not be made as consistency in the object cluster is met, the processing of rollback or aborting is executed. For example, a case of mismatch to update by another unit of processing 40 falls under such case.

The consistency control may be implemented by donating locks to data and executing exclusive control from one unit of processing to another. The locks may differ in strength, such as S-lock, X-lock, IS-lock or IX lock, and are donated by hierarchical locking stated for example in Non-Patent Literature 6. The data, to which the locks are donated, such as the entire object cluster, objects or metadata in the objects, differ in granularity. The consistency control may be implemented using an SI (Snapshot Isolation) technique as stated in Non-Patent Literature 7. In this SI technique, a plurality of versions of an object is stored and control is exercised as to which of the versions is to be provided from one unit of processing to another. It should be noted that the consistency control in the present exemplary embodiment is not limited to the above mentioned techniques.

Consistency control of the objects, performed by the data processing devices 10a to 10, specifically, by an operation of the unit of processing to cluster association resolving unit 21, object to cluster association resolving unit 22 and the consistency control unit 23, will now be described in detail.

The unit of processing to cluster association resolving unit 21 stores information as to which unit of processing 40 has so far had to do with which objects belonging to which object clusters. The unit of processing to cluster association resolving unit 21 receives an identifier that specifies an object cluster to output a list of identifiers of the units of processing having to do with the objects. Additionally, the unit of processing to cluster association resolving unit 21 receives identifiers that specify the plurality of the object clusters and outputs a list of identifiers of the units of processing that have to do with two or more of these object clusters and that have not been committed.

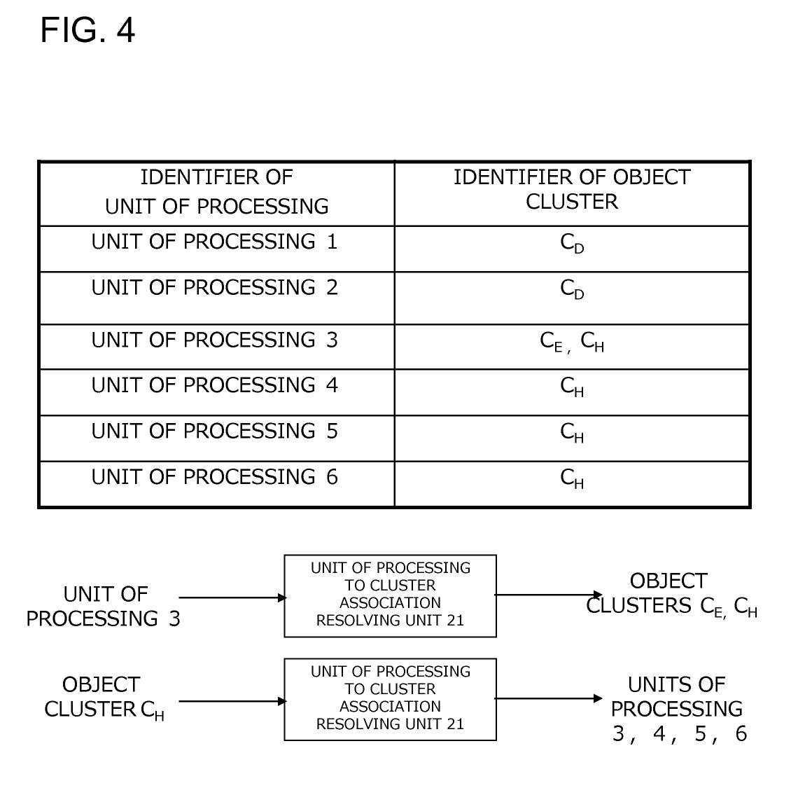

FIG. 4 shows, as an example, processing by the unit of processing to cluster association resolving unit 21. The table of FIG. 4 correlates the identifiers of the units of processing with the identifiers of the object clusters and stores the so correlated identifiers. In case the units of processing and the object clusters are correlated with each other as tabulated in FIG. 4, and the unit of processing to cluster association resolving unit 21 has received an identifier of the unit of processing 3, the unit outputs identifiers of the object clusters C_{E} and C_{H}. On the other hand, if the unit of processing to cluster association resolving unit 21 has received an identifier of the object cluster C_{H}, the unit outputs identifiers of the units of processing 3 to 6.

The object to cluster association resolving unit 22 stores the information as to which object currently belongs to which object cluster. The object to cluster association resolving unit 22 receives an identifier that specifies an object to return an identifier that specifies the object cluster to which the object currently belongs or an identifier of the consistency control unit 23 that manages consistency control of the object cluster in question.

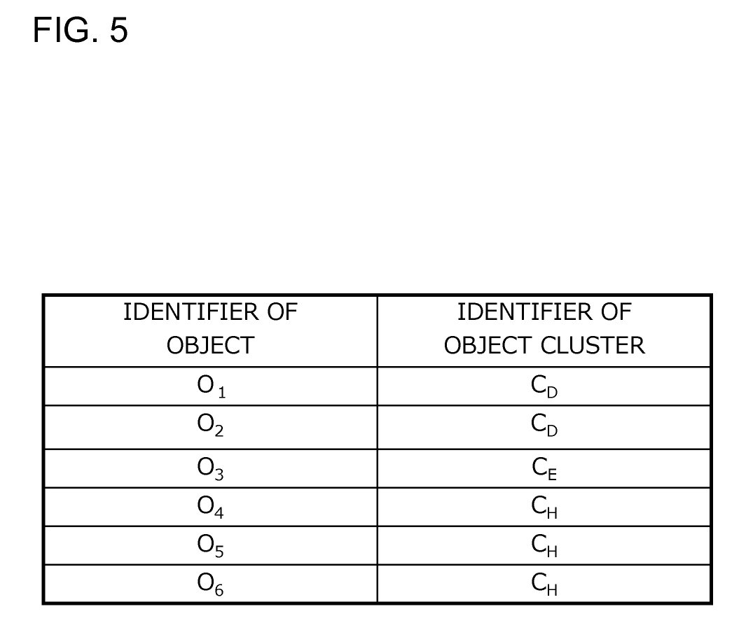

FIG. 5 shows, by way of an example, the relationship of correspondence between objects and object clusters in the object to cluster association resolving unit 22. Referring to FIG. 5, objects O₁ and O₂ are contained in an object cluster C_{D}, an object O₃ is contained in an object cluster C_{E} and objects O₄ to O₆ are contained in an object cluster C_{H}.

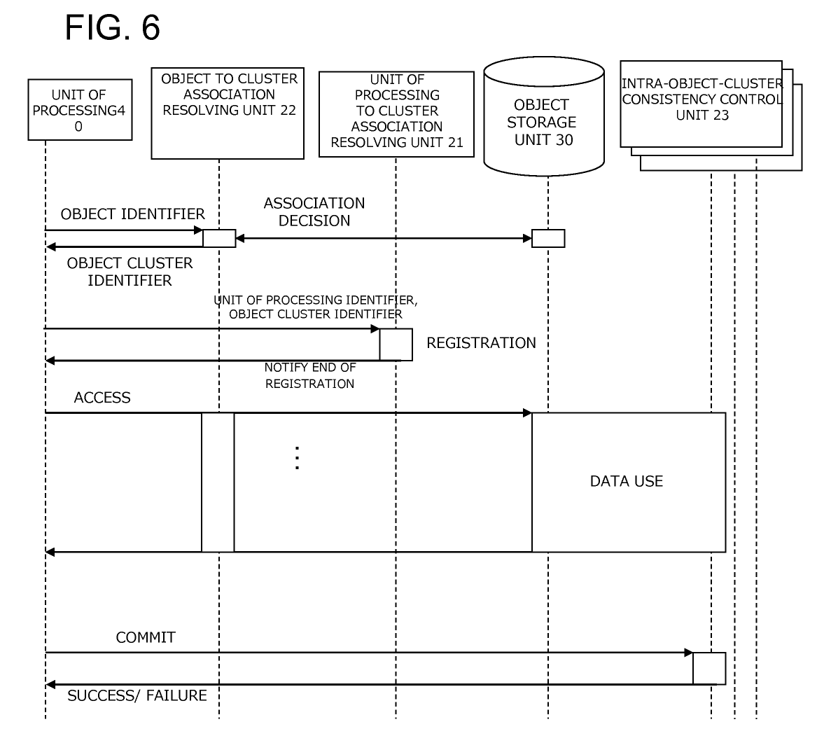

Referring to FIGS. 6 to 8, an operation of referencing or updating of an object by the unit of processing 40 will be explained.

In referencing or updating the object, the unit of processing 40 first acquires, from the object to cluster association resolving unit 22, an identifier that identifies the object cluster to which belongs the object in question. Then, before accessing the object in question, the unit of processing 40 registers, in the unit of processing to cluster association resolving unit 21, an identifier of the unit of processing 40 itself and an identifier that specifies the object cluster of interest. It should be noted that, in case the registration complete state of the unit of processing 40 may be deciphered by taking advantage of the objects or the relevant information on objects in the cluster in question, it is possible to dispense with the registration in the unit of processing to cluster association resolving unit 21.

The unit of processing 40 then accesses data. If, during the accessing by the unit of processing 40, the formulation of the relevant information on objects astride a plurality of object clusters is not involved, consistency management for the accessing by the unit of processing 40 is carried out on the object class basis in accordance with the above mentioned conventional technique. FIG. 6 depicts a sequence diagram showing the processing not astride the object clusters, as an example.

When data accessing has come to a close, the unit of processing 40 issues a commit command to each of the consistency control units 23. In case the formulation of the relevant information on objects 32 across a plurality of object clusters is not involved, it is in each of the consistency control units 23 that success or failure of commit is determined. The success or failure of commit is checked based on whether or not change to data by the unit of processing in question influences read/write in the remaining processes.

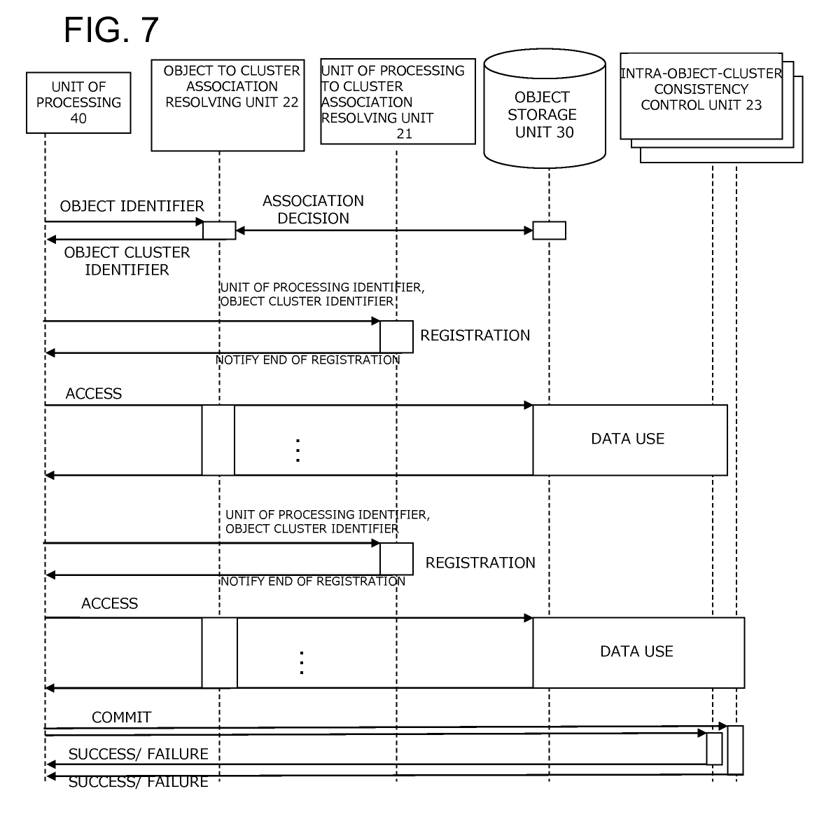

The degree of such influence on the remaining units of processing is determined by conditions as set by the user or the system in advance. The decisions or conditions may be those adopted in the conventional technique. For example, if the transaction isolation level is serializable, the commit in question is regarded as being successful (true) in case the total of the processing conditions are temporally not overlapped and the data state is the same as that in case of serial execution. If part of the commits should have failed, the remaining commits are done successfully. FIG. 7 depicts a sequence diagram showing, as an example, processing which is astride the object clusters but in which no linkage of the object clusters has occurred.

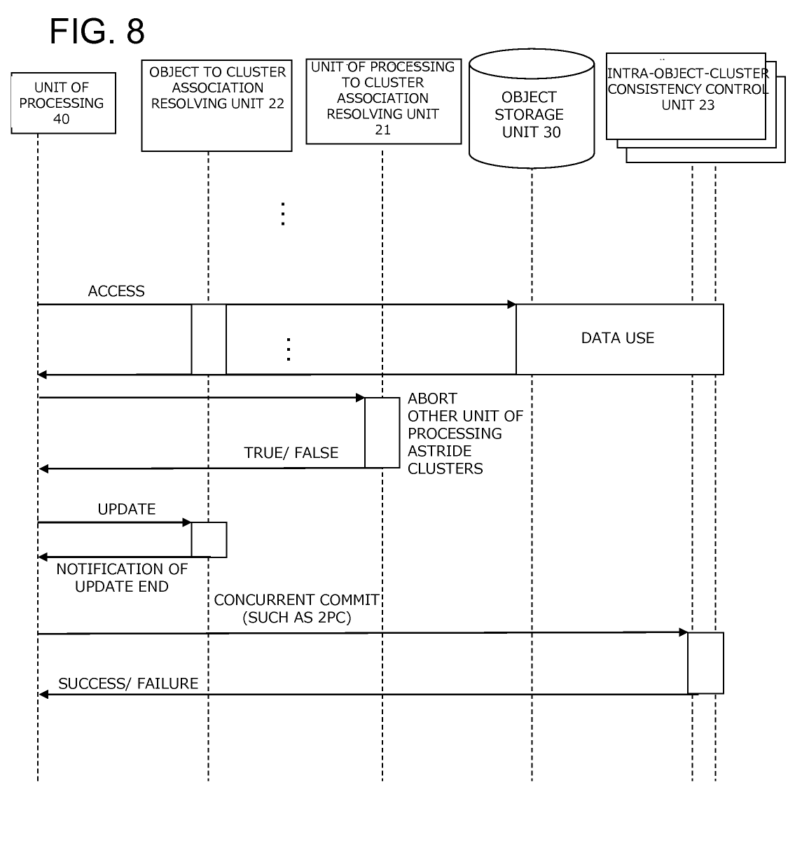

It is assumed that the relevant information on objects 32 astride the multiple object clusters has been generated by a certain unit of processing 40. FIG. 8 depicts a sequence diagram showing, as an example, processing in case a relation across the multiple object clusters has been generated. In this case, the unit of processing 40 utilizes the unit of processing to cluster association resolving unit 21 to specify a unit of processing that is astride two or more of the relevant object clusters. The unit of processing 40 then aborts processing of the specified process. The unit of processing 40 also commands linking the object clusters of interest. The object to cluster association resolving unit 22 rewrites the information so that the total of the objects in the object cluster in question will correspond to a single object cluster. Finally, the object to cluster association resolving unit issues a commit command to the consistency control units 23 corresponding to the respective object clusters at the same time.

Here, a 2PC commit (Two Phase Commit), may, for example, be used. That is, a 2PC prepare (prepare commit) message is issued to the total of the consistency control units 23. The consistency control units 23 decide whether or not the commit in question will be successful (true). If the commit is to fail, the consistency control units 23 return failure (false). On the other hand, if the commit is successful, the consistency control units 23 lock the total of the resources that will obstruct the commit, and return success. The unit of processing 40 sends out a 2PC-commit (commit execute) message. The total of the consistency control units 23 cause data update to be reflected and releases the lock as necessary.

The consistency control is managed on the object cluster basis in a manner described above. By so doing, it is possible to implement an application which it would have been impossible to implement with the conventional object-based consistency control. Also, the processing other than processing of linking the object clusters is completed at the individual consistency control units 23. Thus, even in case the parallel data processing system 100 includes a plurality of the data processing devices 10a to 10c, it is possible to accomplish scalability proportional to the number of the object clusters.

### Second Exemplary Embodiment

A parallel data processing system according to a second exemplary embodiment will now be described in detail with reference to the drawings. In the present exemplary embodiment, the processing in the object to cluster association resolving unit 22 in the first exemplary embodiment is executed in two stages to improve the performance of processing to update the information by the object to cluster association resolving unit 22.

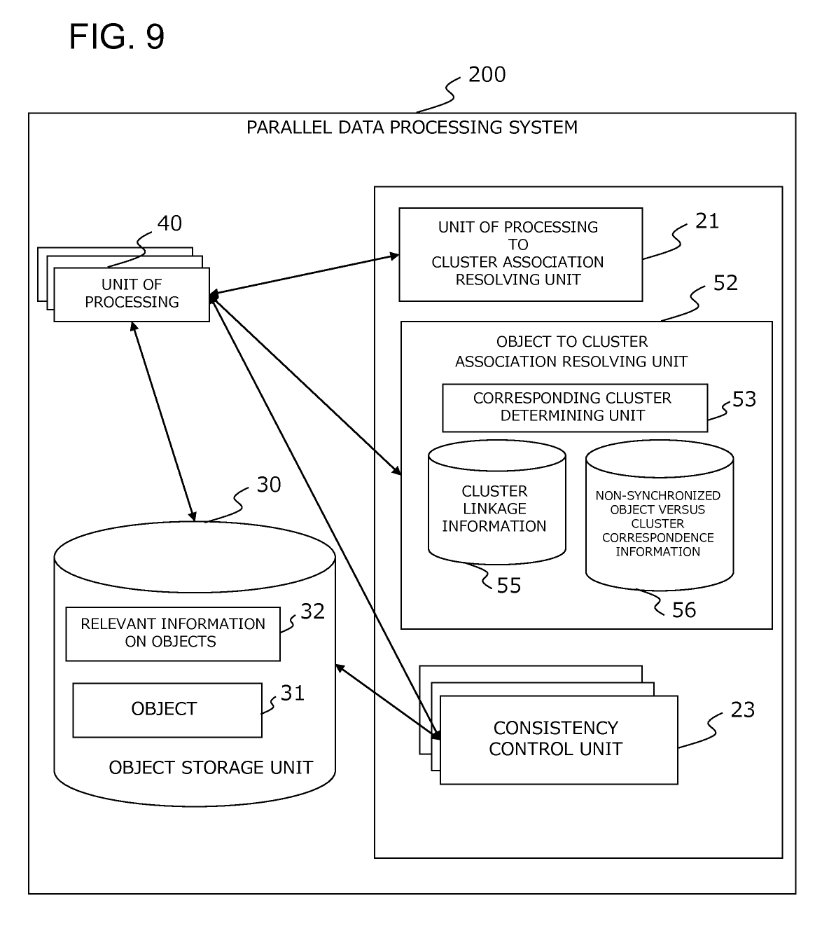

FIG. 9 depicts a block diagram showing a configuration of a parallel data processing system 200 of the present exemplary embodiment. Referring to FIG. 9, an object to cluster association resolving unit 52 of the present exemplary embodiment also includes a corresponding cluster determining unit 53, a cluster linkage information 55 and non-synchronized object versus cluster correspondence information 56.

The object to cluster association resolving unit 52 stores information as to which object currently belongs to which object cluster. The object to cluster association resolving unit 52 receives an identifier that specifies an object and returns an identifier that specifies the object cluster to which the object currently belongs or an identifier of the consistency control unit 23 that manages consistency control regarding the object cluster in question.

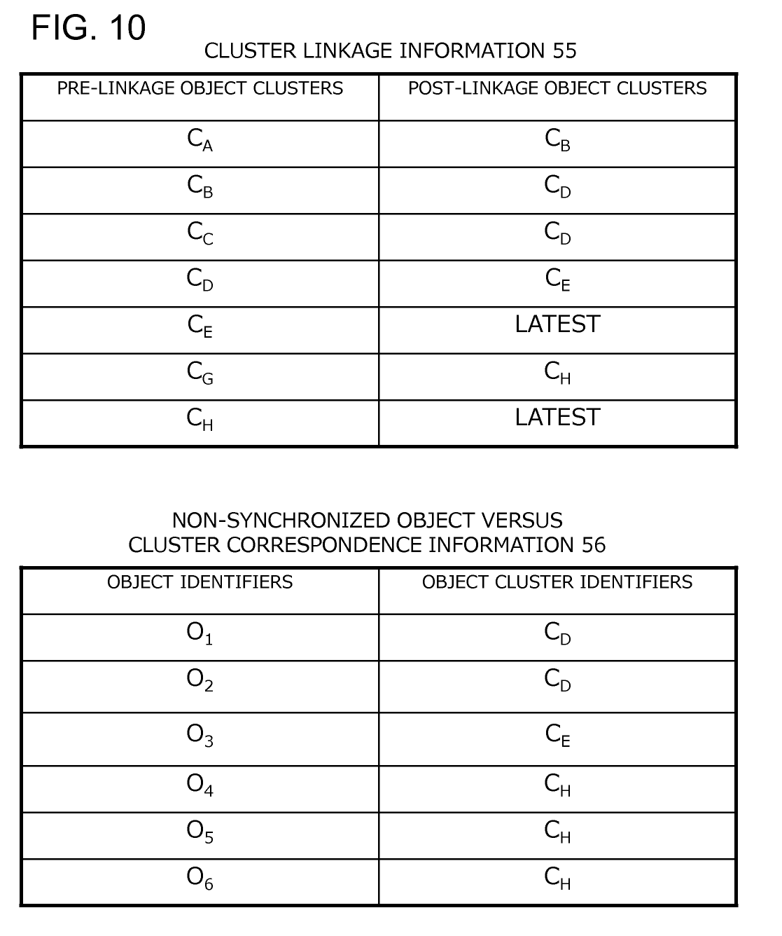

When the object cluster that existed in the past has been linked to another cluster, the cluster linkage information 55 stores information representing the linkage. FIG. 10 shows the cluster linkage information 55 as an example. Based on the cluster linkage information 55, it may be seen to which of the object clusters is currently linked each object cluster.

Referring to FIG. 10, an object cluster C_{A}, for example, is currently linked to an object cluster C_{B}. An object cluster C_{B} is currently linked to an object cluster C_{D}, which object cluster C_{D} is linked to an object cluster C_{E}. Thus, from the cluster linkage information 55, shown in FIG. 10, it is seen that the object cluster C_{A} is currently linked to the object cluster C_{E}.

The non-synchronized object versus cluster correspondence information 56 is information that has been non-synchronously updated and indicates which object belongs to which object cluster. FIG. 10 shows an example of the non-synchronized object versus cluster correspondence information 56. Based on the non-synchronized object versus cluster correspondence information 56, it is possible to get an object cluster for a given object. It should be noted that non-synchronized update means that, if object linkage has occurred, it is not immediately necessary or is wholly unnecessary to update the non-synchronized object versus cluster correspondence information 56.

The corresponding cluster determining unit 53 receives an identifier of an object and returns an identifier of the object cluster to which belongs the object. Initially, the corresponding cluster determining unit 53 uses an identifier of the object being accessed and the non-synchronized object versus cluster correspondence information 56 to get the identifier of the object cluster to which the object belonged in the past. The corresponding cluster determining unit 53 then uses the identifier of the object cluster acquired and the cluster linkage information 55 and returns an identifier that indicates the object cluster in which the object in question currently exists and also indicates the consistency control unit 23 which is currently managing the object in question.

If, in the parallel data processing system 200 of the present exemplary embodiment, two object clusters have linked together, it is only necessary to update a single row of the cluster linkage information 55. On the other hand, if the parallel data processing system 100 of the first exemplary embodiment is used, the number of the information of the object cluster that is to be updated and that includes the objects equals the number of the objects. Thus, in the present exemplary embodiment, speed of the update processing by the object to cluster association resolving unit 52 can be made faster than in the first exemplary embodiment.

### Third Exemplary Embodiment

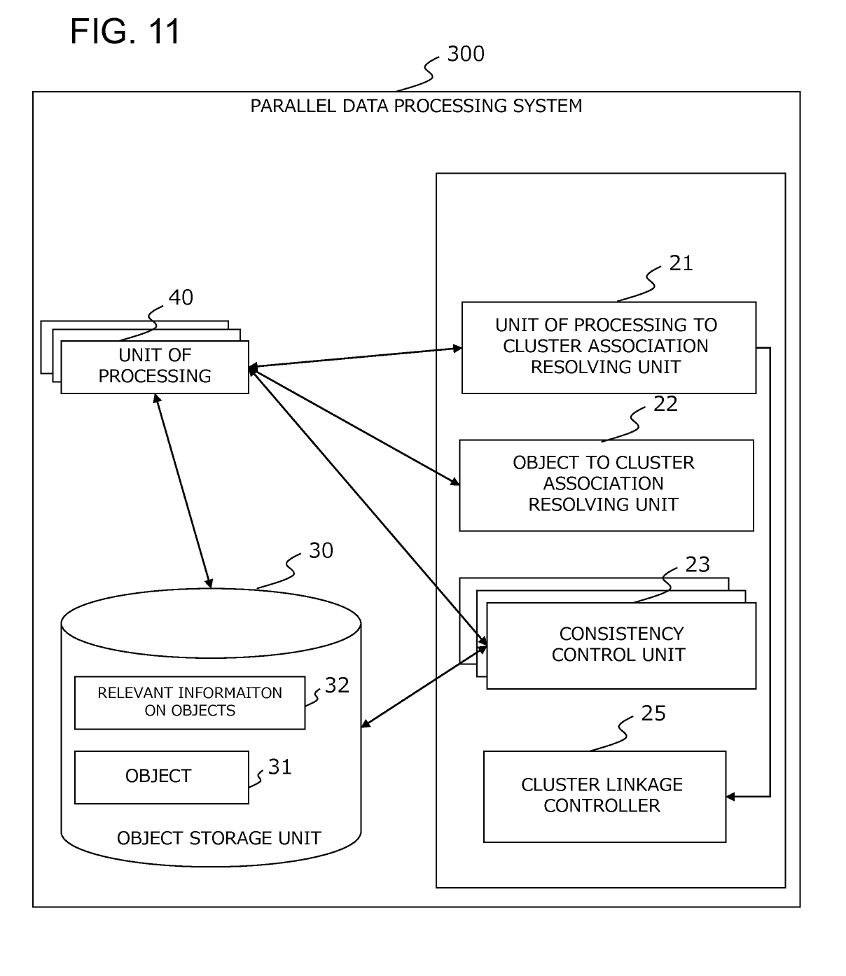

A parallel data processing system according to a third exemplary embodiment will now be described with reference to the drawings. FIG. 11 depicts a block diagram showing a configuration of a parallel data processing system 300 of the present exemplary embodiment.

Referring to FIG. 11, the parallel data processing system according to the exemplary embodiment further includes a cluster linkage controller 25 in the parallel data processing system 100 of the above mentioned first exemplary embodiment (FIG. 1).

When an operation of linking a plurality of object clusters is generated from a unit of processing 40 and the unit of processing 40 is committed, the cluster linkage controller 25 acquires, from the unit of processing to cluster association resolving unit 21, a process, which is performing processing astride a plurality of object clusters of interest, but which has not been committed. The cluster linkage controller 25 issues a command to abort the processing of the acquired process.

It is also possible for the consistency control unit 23 to manage consistency control based on MVCC (Multiversion Concurrency Control) that exploits a plurality of versions of objects. It is preferable for the cluster linkage controller 25 to provide a read-only unit of processing among the non-committed units of processing with a version of an object that precedes the linking of the object clusters.

The disclosure of the above Patent Literatures and Non-Patent Literatures is incorporated herein by reference thereto. Modifications and adjustments of the exemplary embodiments are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

The parallel data processing system, parallel data processing method and the program, according to the present invention, may be applied to a parallel database, a distributed storage, a parallel filing system, a distributed database, a data grid or to a cluster computer.
10a to 10c data processing device
11a to 11c CPU
12a to 12c data storage unit
13a to 13c data transfer unit
21 unit of processing to cluster association resolving unit
22, 52 object to cluster association resolving unit
23 consistency control unit
25 cluster linkage controller
30 object storage unit
31, O₁ to O₁₂, O_{X}, O_{Y} object
32 relevant information on objects
40 unit of processing
53 corresponding cluster determining unit
55 cluster linkage information
56 non-synchronized object versus cluster correspondence information
60 network
70 user computer
100, 200, 300 parallel data processing system
C_{A} to C_{H} object cluster

1. A parallel data processing system comprising:
an object storage unit that holds a plurality of objects and relevant information on objects representing a relation among the plurality of objects;
a unit of processing that generates, reads out or updates an object or the relevant information on objects for the object storage unit;
a plurality of consistency controllers each provided for an object cluster that includes a set of objects related with each other through the relevant information on objects; each consistency controller returning to the unit of processing a consistency value for an object within each object cluster; and
an object to cluster association resolving unit that receives an identifier of an object to return an identifier of an object cluster including the object or an identifier of a consistency controller among the plurality of consistency controllers that is for an object cluster including the object, wherein
in generating, reading out or updating an object or relevant information on objects, the unit of processing acquires, from the object to cluster association resolving unit, an identifier of a consistency controller among the plurality of consistency controllers that is for an object cluster including the object; the unit of processing performing consistency control, based on the consistency controller, while the unit of processing accesses the object storage unit.

2. The parallel data processing system according to claim 1, wherein
the object to cluster association resolving unit comprises:
non-synchronized object versus cluster correspondence information that stores a relation between an identifier of an object and an identifier of a object cluster including the object, the relation being asynchronously updated;
cluster linkage information that, in case an object cluster is integrated to another object cluster, stores an identifier of the object cluster that has become extinct by the integration and an identifier of the object cluster as destination of the integration, in relation with each other; and
a corresponding cluster determining unit that receives an identifier of an object to acquire, from the identifier of the object and the non-synchronized object versus cluster correspondence information, an identifier of an object cluster to which the object belonged in the past, acquires, from the identifier of the object cluster and the cluster linkage information, an identifier of an object cluster to which the object currently belongs, or an identifier of a consistency controller among the plurality of consistency controllers that corresponds to the object cluster, and returns the acquired identifier.

3. The parallel data processing system according to claim 1, further comprising:
a unit of processing to cluster association resolving unit that correlates and stores an identifier of a unit of processing and an identifier of an object cluster including an object being accessed by the process, wherein
the process, in forming, reading out or updating the object or the relevant information on objects, acquires, from the object to cluster association resolving unit, an identifier of a corresponding object cluster and an identifier of a consistency controller among the plurality of consistency controllers that is for the object cluster, and registers, before accessing to the object cluster, an identifier of the unit of processing and an identifier of the object cluster in the unit of processing to cluster association resolving unit.

4. The parallel data processing system according to claim 3, further comprising:
a cluster linkage controller which, if an operation of linking a plurality of object clusters is generated from a process, acquires, from the unit of processing to cluster association resolving unit, a unit of processing which are performing processing for an object included in the plurality of object clusters and which has not been committed, and issues a command to abort the processing of the non-committed process.

5. The parallel data processing system according to claim 4, wherein
the consistency controllers performs consistency control by MVCC (Multiversion Concurrency Control) that exploits a plurality of versions of objects, and
the cluster linkage controller provides a read-only unit of processing among the non-committed units of processing with a version of an object that precedes the linking of the plurality of object clusters.

6. The parallel data processing system according to claim 1, wherein
the object is one among a file of a file system, a set of metadata relevant to a file, a tuple of a relational database, data of an object database, a Key-values of a Key-Value store, a content delimited by tags of an XML document and a resource of an RDF (Resource Description Framework) document.

7. The parallel data processing system according to claim 1, wherein
the relevant information on objects includes bi-directional or uni-directional relation among objects.

8. A parallel data processing method, in a parallel data processing system comprising:
an object storage unit that holds a plurality of objects and relevant information on objects representing a relation among the plurality of objects;
a unit of processing that generates, reads out or updates an object or the relevant information on objects for the object storage unit;
a plurality of consistency controllers each of which is provided for an object cluster that includes a set of objects related with each other through the relevant information on objects; each consistency controller returning to the unit of processing a consistency value for an object within each object cluster; and
an object to cluster association resolving unit that receives an identifier of an object to return an identifier of a consistency controller among the plurality of consistency controllers that is for an object cluster including the object, the method comprising:
by the unit of processing, in generating, reading out or updating an object or relevant information on objects, acquiring, from the object to cluster association resolving unit, an identifier of a consistency controller among the plurality of consistency controllers that is for an object cluster including the object; and
performing consistency control, based on a consistency controller among the plurality of consistency controllers that corresponds to the acquired identifier, while the unit of processing accesses the object storage unit.

9. A non-transitory computer-readable storage medium storing a program, in a parallel data processing system comprising:
an object storage unit that holds a plurality of objects and relevant information on objects representing a relation among the plurality of objects;
a unit of processing that generates, reads out or updates an object or the relevant information on objects for the object storage unit;
a plurality of consistency controllers each provided for an object cluster that includes a set of objects related with each other through the relevant information on objects; each consistency controller returning to the unit of processing a consistency value for an object within each object cluster; and
an object to cluster association resolving unit that receives an identifier of an object to return an identifier of a consistency controller among the plurality of consistency controllers that is for an object cluster including the object, the program causing a computer to execute:
in generating, reading out or updating an object or the relevant information on objects, acquiring, from the object to cluster association resolving unit, an identifier of a consistency controller among the plurality of consistency controllers that is for an object cluster including the object; and
performing consistency control, based on a consistency controller among the plurality of consistency controllers that corresponds to the acquired identifier, while accessing the object storage unit.
